(19) United States
(12) Patent Application Publication
(10) Pub. No.: US 2013/0222553 A1
(43) Pub. Date: Aug. 29, 2013

(54) IMAGE PICKUP DEVICE AND IMAGE PICKUP APPARATUS

(71) Applicant: FUJIFILM CORPORATION, (US)

(72) Inventor: Akiyoshi TSUCHITA, Saitama-shi (JP)

(73) Assignee: FUJIFILM CORPORATION, Tokyo (JP)

(21) Appl. No.: 13/846,550

(22) Filed: Mar. 18, 2013

Related U.S. Application Data
(63) Continuation of application No. PCT/JP2011/065314, filed on Jul. 5, 2011.

(30) Foreign Application Priority Data
Sep. 24, 2010 (JP) 2010-214103

(51) Int. Cl. H04N 13/02

(52) U.S. Cl. CPC H04N 13/0285
USPC 348/49

(57) ABSTRACT

An image pickup device, comprising: a plurality of photoelectric conversion elements; a first microlens; and a second microlens, which is one microlens provided above n×n (n: 2 or more) of the photoelectric conversion elements laterally and longitudinally adjacent to each other, the second microlens pupil-dividing light entering the microlens for guiding to a light receiving surface of each of the n×n photoelectric conversion elements, the first microlens and the second microlens being provided in a mixed manner so that a two-dimensional image and a three-dimensional image can be respectively generated based on at least a first output signal corresponding to the first microlens and a second output signal corresponding to the second microlens, color filters of any of the colors being provided above the plurality of photoelectric conversion elements, and color filters of a same color being provided to the n×n photoelectric conversion elements corresponding to the second microlens.

### CROSS-REFERENCE TO RELATED APPLICATIONS

This application is a continuation application and claims the priority benefit under 35 U.S.C. §120 of PCT Application No. PCT/JP2011/065314 filed on Jul. 5, 2011 which application designates the U.S., and also claims the priority benefit under 35 U.S.C. §119 of Japanese Patent Application No. 2010-214103 filed on Sep. 24, 2010, which applications are all hereby incorporated by reference in their entireties.

### TECHNICAL FIELD

The present invention is an image pickup device and image pickup apparatus and, in particular, relates to an image pickup device and image pickup apparatus capable of imaging a two-dimensional image (a 2D image) and a three-dimensional image (a 3D image).

### BACKGROUND ART

Conventionally, an image processing apparatus has been suggested that is capable of using an image pickup element with one microlens allocated to a plurality of pixels to insert any given two-dimensional image in any given depth direction in a stereoscopic image (Patent Literature 1). This Patent Literature 1 describes that a plurality of parallax images with different parallaxes are generated from a plurality of pixels to which one microlens is allocated.

Also, a stereoscopic video imaging apparatus has been suggested that is configured such that a lens array camera having a plurality of lenses in an array and a normal camera are placed so as to be aligned in a horizontal direction and one lens eye camera is used to image a plurality of parallax images from images at low resolution and the other camera is used to image video at high resolution so that a vector of a parallax between the cameras and a vector of a parallax of the lens array camera coincide with each other (Patent Literature 2). The video imaged by this stereoscopic video imaging apparatus includes a plurality of videos with fine parallax spacing and one video with a large parallax spacing having a vector identical to that of this video. Regarding resolution, videos with fine resolution and videos with rough resolution are included. By interpolating the parallax and resolution, images with large parallax and high resolution can be imaged.

### CITATION LIST

### Patent Literatures

PTL 1: Japanese Patent Application Laid-Open No. 2010-68018
PTL 2: Japanese Patent Application Laid-Open No. 2010-78768

### SUMMARY OF INVENTION

### Technical Problem

The two-dimensionally arranged plurality of microlenses (the microlens array) described in Patent Literature 1 are provided on an imaging surface of an imaging lens, and the image pickup elements are arranged at a imaging position of this microlens array. A pencil of light enters each pixel of the image pickup elements via the microlens array.

Therefore, while the image pickup apparatus described in Patent Literature 1 can obtain a plurality of parallax images with different parallaxes from a plurality of pixels to which one microlens is allocated, the image pickup apparatus cannot obtain a 2D image at high resolution. Also, while Patent Literature 1 describes that color filters may be two-dimensionally arranged per image pickup element (paragraph [0022] in Patent Literature 1), but Patent Literature 1 does not describe that the same color filters are placed per a plurality of pixels to which one microlens is allocated.

On the other hand, in the stereoscopic video imaging apparatus described in Patent Literature 2, two cameras, that is, a lens array camera and a normal camera, are required, thereby disadvantageously making the apparatus hefty and increasing cost.

The present invention has been made in view of these circumstances, and has an object of providing an image pickup device and image pickup apparatus that are down-sizable at low cost, capable of imaging a two-dimensional image at high resolution and also imaging a three-dimensional image.

### Solution to Problems

To achieve the object described above, an image pickup device according to the present invention includes a plurality of photoelectric conversion elements arranged in a row direction and a column direction on a semiconductor substrate; a first microlens, which is one microlens provided above one of the photoelectric conversion elements, the first microlens guiding light entering the microlens to a light receiving surface of the one photoelectric conversion element; and a second microlens, which is one microlens provided above n×n (n: an integer of 2 or more) of the photoelectric conversion elements laterally and longitudinally adjacent to each other, the second microlens pupil-dividing light entering the microlens for guiding to a light receiving surface of each of the n×n photoelectric conversion elements, the first microlens and the second microlens are provided in a mixed manner so that a two-dimensional image and a three-dimensional image can be respectively generated based on at least a first output signal from the photoelectric conversion element corresponding to the first microlens and a second output signal from any of the photoelectric conversion elements corresponding to the second microlens.

The image pickup device according to the present invention is configured to include a 1-pixel 1-microlens part having one microlens provided for one photoelectric conversion element (one pixel) and an n×n-pixel 1-microlens part having one microlens provided for n×n photoelectric conversion elements (n×n pixels) laterally and longitudinally adjacent to each other are provided in a mixed manner. A two-dimensional image at high resolution can be generated from a first output signal outputted from the 1-pixel 1-microlens part with a small pixel pitch. On the other hand, a three-dimensional image can be generated from a second output signal outputted from the n×n-pixel 1-microlens part from which parallax images at n×n viewpoints can be obtained.

In this image pickup device, of color filters of a plurality of colors, color filters of any of the colors is provided above the plurality of photoelectric conversion elements, and color filters of a same color are provided to the n×n photoelectric conversion elements corresponding to the second microlens. That is, with the same color of the color filters per n×n-pixel 1-microlens part, pixel addition can be performed as required.

In this image pickup device, the number of photoelectric conversion elements where the first microlens is provided and the number of photoelectric conversion elements where the second microlens is provided are equal to each other.

In this image pickup device, 4×4 photoelectric conversion elements are taken as one block, and a first region where sixteen first microlenses are provided to one block and a second region where four second microlenses are provided to one block are arranged in a checkered manner. With this, the arrangement of the color filters can be made as the Bayer arrangement.

In this image pickup device, 2×2 photoelectric conversion elements are taken as one block, and a first region where four first microlenses are provided to one block and a second region where one second microlenses are provided to one block are arranged in a checkered manner.

An image pickup apparatus according to the present invention includes a single imaging optical system; the image pickup device where the subject image is formed via the imaging optical system; an imaging mode selecting unit that switches between a 2D imaging mode for imaging a two-dimensional image and a 3D imaging mode for imaging a three-dimensional image; a first image generating unit that generates a two-dimensional image based on a first output signal outputted from the photoelectric conversion element corresponding to the first microlens of the image pickup device when the 2D imaging mode is selected by the imaging mode selecting unit; a second image generating unit that generates a three-dimensional image based on a second output signal outputted from the photoelectric conversion element corresponding to the second microlens of the image pickup device when the 3D imaging mode is selected by the imaging mode selecting unit; and a recording unit that records the two-dimensional image generated by the first image generating unit or the second generating unit or the three-dimensional image generated by the second image generating unit.

According to the present invention, depending on whether the mode is the 2D imaging mode or the 3D imaging mode, switching is made between the first output signal outputted from the 1-pixel 1-microlens part and the second output signal outputted from the 4-pixel 1-microlens part. When the 2D imaging mode is selected, a two-dimensional image at high resolution can be generated based on the first output signal. When the 3D imaging mode is selected, a three-dimensional image (a plurality of parallax images) can be generated based on the second output signal.

An image pickup apparatus according to the present invention includes a single imaging optical system; the image pickup device where the subject image is formed via the imaging optical system; an imaging mode selecting unit that switches between a 2D imaging mode for imaging a two-dimensional image and a 3D imaging mode for imaging a three-dimensional image; a determining unit that determines whether an image imaged via the imaging optical system and the image pickup device includes many high-frequency components; a first image generating unit that generates a two-dimensional image based on a first output signal outputted from the photoelectric conversion element corresponding to the first microlens of the image pickup device when the 2D imaging mode is selected by the imaging mode selecting unit and it is determined by the determining unit that the image includes many high-frequency components, and generates a two-dimensional image based on a second output signal outputted from the photoelectric conversion element corresponding to the second microlens of the image pickup device when it is determined by the determining unit that the image does not include many high-frequency components; and a second image generating unit that generates a three-dimensional image based on the second output signal outputted from the photoelectric conversion element corresponding to the second microlens of the image pickup device when the 3D imaging mode is selected by the imaging mode selecting unit; and a recording unit that records the two-dimensional image generated by the first image generating unit or the three-dimensional image generated by the second image generating unit.

According to the present invention, when imaging at high resolution is required particularly if the 2D imaging mode is selected (when the image includes many high-frequency components), a two-dimensional image at high resolution is generated based on the first output signal. When imaging at high resolution is not required (when the image does not include many high-frequency components), a two-dimensional image is generated based on the second output signal. Note that when a two-dimensional image is generated based on the second output signal, addition of four pixels corresponding to one microlens is performed to make one pixel.

This image pickup apparatus further includes a brightness detecting unit that detects a brightness of a subject, and the first image generating unit generates a two-dimensional image based on the first output signal outputted from the photoelectric conversion element corresponding to the first microlens of the image pickup device when the 2D imaging mode is selected by the imaging mode selecting unit, it is determined by the determining unit that the image includes many high-frequency components, and the detected brightness of the subject exceeds a predetermined threshold, and generates a two-dimensional image based on the second output signal outputted from the photoelectric conversion element corresponding to the second microlens of the image pickup device when it is determined by the determining unit that the image does not include many high-frequency components or when the detected brightness of the subject is the predetermined threshold or less.

According to the present invention, when imaging at high resolution is required particularly if the 2D imaging mode is selected (when the image includes many high-frequency components) and when the brightness of the subject exceeds a predetermined brightness, a two-dimensional image at high resolution is generated based on the first output signal. On imaging conditions except the above, a two-dimensional image is generated based on the second output signal.

In the case of an imaging environment where a sufficient brightness cannot be obtained, an image with less noise is often required even if the image is at resolution lower than that of an image at high resolution. According to the present invention, if the brightness of the subject is the predetermined brightness or less, a two-dimensional image is generated based on the second output signal even if the image includes many high-frequency components.

The present invention includes a single imaging optical system; the image pickup device where the subject image is formed via the imaging optical system; an imaging mode selecting unit that switches between a 2D imaging mode for imaging a two-dimensional image and a 3D imaging mode for imaging a three-dimensional image; a brightness detecting unit that detects a brightness of a subject; a first image generating unit generates a two-dimensional image based on the first output signal outputted from the photoelectric conversion element corresponding to the first microlens of the image pickup device when the 2D imaging mode is selected by the imaging mode selecting unit, and the detected brightness of the subject exceeds a predetermined threshold, and generates a two-dimensional image based on the second output signal outputted from the photoelectric conversion element corresponding to the second microlens of the image pickup device when the detected brightness of the subject is the predetermined threshold or less; a second image generating unit that generates a three-dimensional image based on the second output signal outputted from the photoelectric conversion element corresponding to the second microlens of the image pickup device when the 3D imaging mode is selected by the imaging mode selecting unit; and a recording unit that records the two-dimensional image generated by the first image generating unit or the three-dimensional image generated by the second image generating unit.

According to the present invention, when the brightness of the subject exceeds the predetermined brightness particularly if the 2D imaging mode is selected, a two-dimensional image at high resolution is generated based on the first output signal. When the brightness of the subject is the predetermined brightness or less, a two-dimensional image is generated based on the second output signal. When a two-dimensional image is generated based on the second output signal, pixel addition of n×n pixels is performed. Thus, a desired output signal can be obtained even if the subject is dark.

An image pickup apparatus according to the present invention includes a single imaging optical system; the image pickup device where the subject image is formed via the imaging optical system; an imaging mode selecting unit that switches between a 2D imaging mode for imaging a two-dimensional image and a 3D imaging mode for imaging a three-dimensional image; a determining unit that determines whether an image imaged via the imaging optical system and the image pickup device includes many high-frequency components, determining whether the image includes many high-frequency components for each divisional area obtained by N×M division of one screen; a first image generating unit that, when the 2D imaging mode is selected by the imaging mode selecting unit and it is determined that the image is in a divisional area including many high-frequency components, obtains, for the divisional area, a first output signal outputted from the photoelectric conversion element corresponding to the first microlens of the image pickup device, obtains a second output signal outputted from the photoelectric conversion element corresponding to the second microlens of the image pickup device when it is determined that the image is in a divisional area not including many high-frequency components, and generates a two-dimensional image based on the obtained first output signal and second output signal; a second image generating unit that generates a three-dimensional image based on the second output signal outputted from the photoelectric conversion element corresponding to the second microlens of the image pickup device when the 3D imaging mode is selected by the imaging mode selecting unit; and a recording unit that records the two-dimensional image generated by the first image generating unit or the three-dimensional image generated by the second image generating unit.

According to the present invention, depending on, for each divisional area obtained by dividing one screen into N×M divisions, whether the divisional area includes many high-frequency components particularly if the 2D imaging mode is selected, an appropriate output signal between the first output signal and the second output signal is selected and obtained from each divisional area.

In this image pickup apparatus, the second image generating unit generates parallax images of four viewpoints from above, below, left and right or parallax images of two viewpoints from above and below or from left and right, based on a second output signal outputted from the photoelectric conversion element corresponding to the second microlens of the image pickup device.

### Advantageous Effects of Invention

According to the present invention, with the novel image pickup device having the 1-pixel 1-microlens part and the 4-pixel 1-microlens part mixed therein, it is possible to image a 2D image at high resolution and to image a 3D image, and also to achieve a decrease in cost and size of the apparatus.

### BRIEF DESCRIPTION OF DRAWINGS

FIG. 1 is a plan view of main parts of a first embodiment of an image pickup device according to the present invention.

FIG. 2A is a diagram of a 1-pixel 1-microlens part in the image pickup device.

FIG. 2B is a diagram of a 4-pixel 1-microlens part in the image pickup device.

FIG. 3 is a plan view of main parts depicting a second embodiment of the image pickup device according to the present invention.

FIG. 4 is a block diagram of an embodiment of an image pickup apparatus according to the present invention.

FIG. 5A is a diagram of pixels of the 4-pixel 1-microlens part.

FIG. 5B is a diagram for describing a method of adding pixels in the 4-pixel 1-microlens part.

FIG. 6 is a block diagram of an internal structure of a digital signal processing unit of the image pickup apparatus according to the present invention.

FIG. 7 is a flowchart depicting an operation of an image pickup apparatus of a first embodiment of the present invention.

FIG. 8 is a flowchart depicting an operation of an image pickup apparatus of a second embodiment of the present invention.

FIG. 9 is a flowchart depicting an operation of an image pickup apparatus of a third embodiment of the present invention.

FIG. 10 is a flowchart depicting an operation of an image pickup apparatus of a fourth embodiment of the present invention.

FIG. 11 is a flowchart depicting an operation of an image pickup apparatus of a fifth embodiment of the present invention.

### DESCRIPTION OF EMBODIMENTS

Embodiments of the image pickup device and image pickup apparatus according to the present invention are described in accordance with the attached drawings.

### [Image Pickup Device]

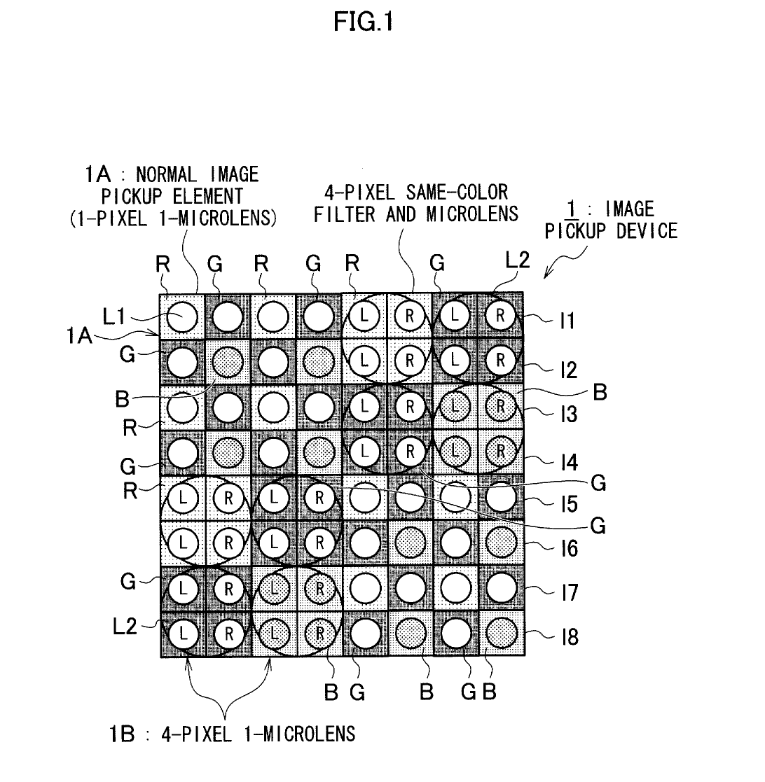

FIG. 1 is a plan view of main parts of a first embodiment of an image pickup device according to the present invention.

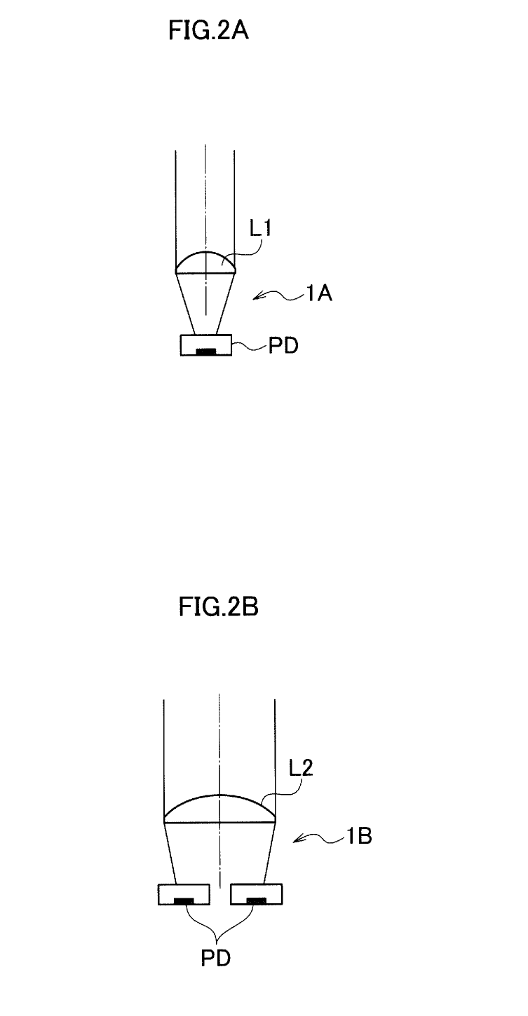

As depicted in FIG. 1, this image pickup device 1 is a CCD or CMOS color image sensor, and is configured to mainly include a plurality of photoelectric conversion elements (photodiodes) PD arranged in a row direction and a column direction on a semiconductor substrate (refer to FIG. 2A and FIG. 2B), microlenses L1 and L2 of two types, that is, small and large, respectively, and color filters of a plurality of colors (three primary colors) of red (R), green (G), and blue (B).

One small microlens L1 is provided for one photodiode PD, and one large microlens L2 is provided for four photodiodes PD laterally and longitudinally close to each other.

In the following, a portion where one microlens L1 is provided for one photodiode PD (one pixel) is referred to as a 1-pixel 1-microlens part 1A, and a portion where one microlens L2 is provided for four photodiodes PD (four pixels) is referred to as a 4-pixel 1-microlens part 1B.

As depicted in FIG. 1, the image pickup device 1 has 1-pixel 1-microlens parts 1A and 4-pixel 1-microlens parts 1B provided in a mixed manner.

Also, a color filter of any one color of R, G, and B is provided to the 1-pixel 1-microlens part 1A. Similarly, a color filter of any one color of R, G, and B is provided to the 4-pixel 1-microlens part 1B. That is, color filters of the same color are provided on four photodiodes PD of the 4-pixel 1-microlens part 1B.

In FIG. 1, color filters in the order of RGRG . . . are provided to the 1-pixel 1-microlens parts 1A on odd-numbered lines 11, 13, 15, 17 . . . , and color filters in the order of GBGB . . . are provided to the 1-pixel 1-microlens parts 1A on even-numbered lines 12, 14, 16, 18 . . . .

On the other hand, color filers in the order of RGRG . . . are provided to the 4-pixel 1-microlens parts 1B on the lines 11, 12, 15, 16 . . . , and color filters in the order of GBGB . . . are provided to the 4-pixel 1-microlens parts 1B on the lines 13, 14, 17, 18 . . . .

That is, in this image pickup device 1, 4×4 pixels are taken as one block, and a first region where sixteen 1-pixel 1-microlens parts 1A are provided to one block and a second region where four 4-pixel 1-microlens parts 1B are provided to one block are placed in a checkered shape, and the color filter arrangement of R, G, and B of the 1-pixel 1-microlens parts 1A and that of the 4-pixel 1-microlens parts 1B are both the Bayer arrangement.

Furthermore, as depicted in FIG. 2A, each microlens L1 of the 1-pixel 1-microlens part 1A gathers a pencil of light onto a light receiving surface of one photodiode PD. On the other hand, each microlens L2 of the 4-pixel 1-microlens part 1B gathers a pencil of light onto light receiving surfaces of the four photodiodes PD (only two are depicted in FIG. 2B), and causes light with the pencil of light restricted for each of four directions, that is, upward, downward, leftward, and rightward (pupil-divided light) to respectively enter the four photodiodes PD.

According to this image pickup device 1, a 2D image at high resolution can be generated based on output signals from 1-pixel 1-microlens parts 1A, and 3D image can be generated based on output signals from the 4-pixel 1-microlens parts 1B. Note that 2D image and 3D image generating methods will be described further below.

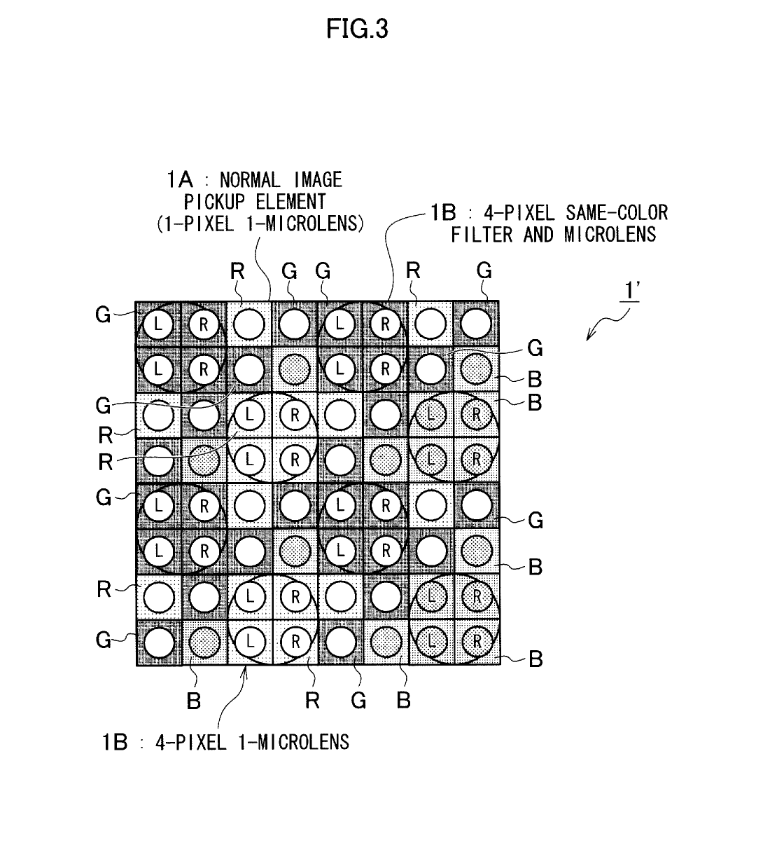

FIG. 3 is a plan view of main parts depicting a second embodiment of the image pickup device according to the present invention.

This image pickup device 1′ is different when compared with the image pickup device 1 depicted in FIG. 1 only in the arrangement of the 1-pixel 1-microlens parts 1A and the 4-pixel 1-microlens parts 1B.

That is, 4-pixel 1-microlens parts 1B of the image pickup device 1′ are placed in a checkered manner, and a 1-pixel 1-microlens part 1A is placed therebetween.

Also, color filters of each 1-pixel 1-microlens part 1A are arranged in the Bayer arrangement, and color filters of each 4-pixel 1-microlens part 1B are arranged in a manner such that G lines and RB lines are alternately placed.

Note that the arrangement of the 1-pixel 1-microlens parts 1A and the 4-pixel 1-microlens parts 1B is not restricted to the embodiments depicted in FIG. 1 and FIG. 3 and, for example, the parts may be arranged in a stripe shape. Also, while the number of photodiodes PD of the 1-pixel 1-microlens parts 1A and that of 4-pixel 1-microlens part 1B are the same in the embodiments depicted in FIG. 1 and FIG. 3, this is not meant to be restrictive, and any number can suffice as long as it is possible to obtain a 2D image at high resolution and obtain a 3D image.

Also, the color filters are not restricted to color filters of R, G, and B, and may be color filters of yellow (Y), magenta (M), cyan (C), and others.

### [Image Pickup Apparatus]

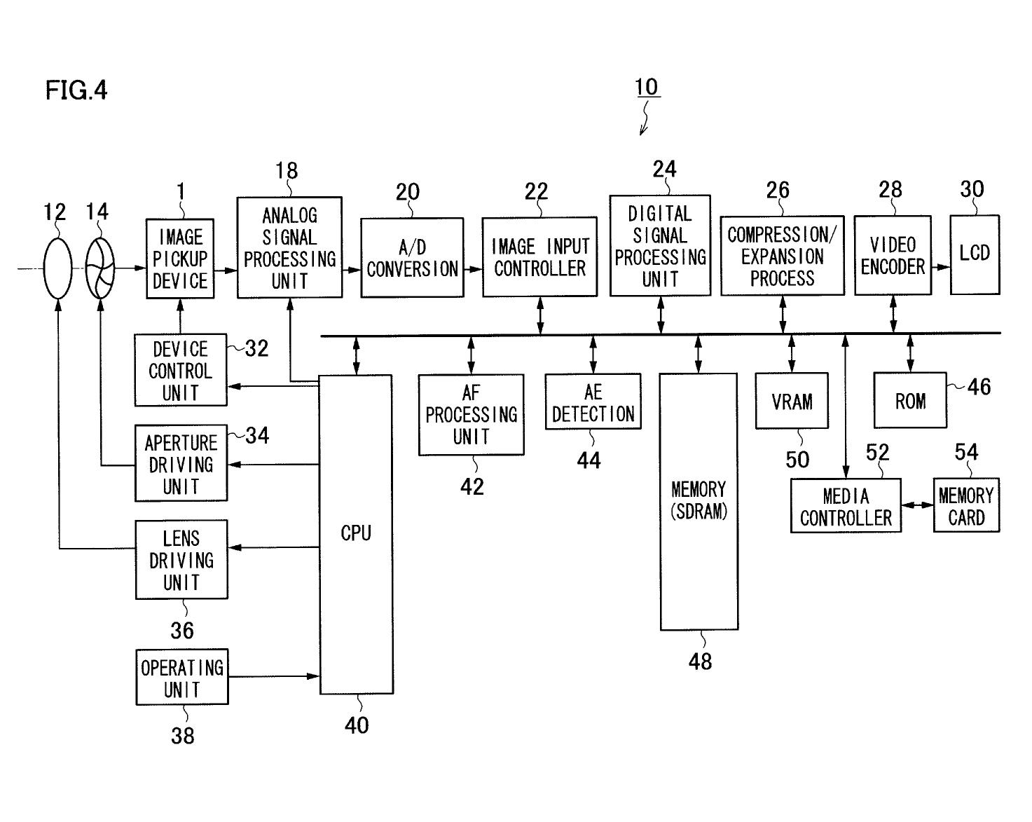

FIG. 4 is a block diagram of an embodiment of an image pickup apparatus 10 according to the present invention.

This image pickup apparatus 10 is provided with the image pickup device 1 depicted in FIG. 1 and can image a 2D image and a 3D image, and the operation of the entire apparatus is controlled by a central processing unit (CPU) 40 in a centralized manner.

The image pickup apparatus 10 is provided with an operating unit 38 including a shutter button, a mode dial, a replay button, a MENU/ON key, a cross key, a BACK key, and others. A signal from this operating unit 38 is inputted to the CPU 40. The CPU 40 controls each circuit of the image pickup apparatus 10, and performs, for example, lens driving control, aperture driving control, imaging operation control, image processing control, image data recording/replay control, and display control over a display monitor 30 for stereoscopic display.

The shutter button is an operation button for inputting an instruction for starting imaging, and is configured to include an S1 switch that is turned ON at the time of being pressed halfway down and an S2 switch that is turned ON at the time of being pressed all the way down. The mode dial is a selecting unit that selects among a 2D imaging mode, a 3D imaging mode, an auto imaging mode, a manual imaging mode, a scene position such as people, landscape, nightscape, and others, a macro mode, a video mode, and a parallax priority imaging mode according to the present invention.

The replay button is a button for switching a still image or a video of a plurality of parallax images (3D images) and a plain image (a 2D image) imaged and recorded to a replay mode for display on a liquid-crystal monitor 30. The MENU/OK key is an operation key having both of a function as a menu button for making an instruction for displaying a menu on a screen of the liquid-crystal monitor 30 and a function as an OK button for making an instruction for establishing and performing a selected operation. The cross key is an operating unit for inputting an instruction in four directions, that is, upward, downward, leftward, and rightward, and functions as a button (cursor movement operating means) for selecting an item from the menu screen and making an instruction for selecting any of various setting items from each menu. The cross key includes up/down keys that function as zoom switches at the time of imaging or a replay zoom switch at the time of the replay mode and left/right keys that function as frame advance (forward direction/reverse direction advance) buttons. The BACK key is used for deletion of a desired target such as a selection item, cancellation of an instruction, return to the immediately-previous operation state, or others.

At the time of the imaging mode, an image of image light indicating a subject is formed on the light-receiving surface of the image pickup device 1 via a single imaging optical system (a zoom lens) 12 and an aperture 14. The imaging optical system 12 is driven by a lens driving unit 36 controlled by the CPU 40, thereby performing focus control, zoom control, and others. The aperture 14 is formed of, for example, five aperture blades, is driven by an aperture driving unit 34 controlled by the CPU 40, and undergoes aperture control, for example, in six stages from an aperture value of F1.4 to an aperture value of F11 in 1 AV steps.

Also, the CPU 40 controls the aperture 14 via the aperture driving unit 34 and performs control via a device control unit 32 over charge storage time (shutter speed) in the image pickup device 1, reading of an image signal from the image pickup device 1, and others.

Signal charge stored in the image pickup device 1 is read as a voltage signal according to the signal charge based on a read signal added from the device control unit 32. A voltage signal read from the image pickup device 1 is added to an analog signal processing unit 18, where R, G, B signals for each pixel are sampled and held, amplified with gain (corresponding to ISO speed) specified by the CPU 40, and then added to an A/D converter 20. The A/D converter 20 converts the sequentially-inputted R, G, and B signals to digital R, G, and B signals for output to an image input controller 22.

A digital signal processing unit 24 performs a predetermined process on the digital image signal inputted via the image input controller 22, such as an offset process, white balance correction, a gain control process including sensitivity correction, a gamma correction process, a synchronization process, a YC process, and sharpness correction.

Note in FIG. 4 that 46 denotes a ROM (EEPROM) having stored therein a camera control program, defect information about the image pickup device 1, various parameters and tables for use in image processing and others, program diagrams (normal program diagrams) such as an aperture priority program diagram, a shutter speed priority program diagram, or a program diagram that alternately or simultaneously changes the aperture and shutter speed depending on the brightness of the subject, as well as a program diagram for parallax priority and others.

The program diagram for parallax priority is designed in a manner such that, for example, the F value takes a constant value of 5.6 (AV=5) and only the shutter speed is changed from 1/60 seconds (TV=6) to 1/2000 (TV=11) according to the imaging EV value when the imaging EV value is from 11 to 16. It is also designed that, when the imaging EV value is smaller than 11 (when it is dark), with the F value=5.6 and the shutter speed= 1/60 seconds being fixed, the ISO speed is from 100 to 200, 400, 800, 1600, and 3200 every time the imaging EV value is decreased by 1 EV. Note that not only the program diagram for parallax priority but also parallax images at four viewpoints obtained from an output signal from each of the 4-pixel 1-microlens parts 1B of the image pickup device 1 have their parallaxes changed depending on the size of the aperture opening, and therefore the aperture opening may be controlled so as not to be smaller than a predetermined aperture opening at the time of the 3D imaging mode.

The digital signal processing unit 24 performs image processing according to an imaging mode determined between the 2D imaging mode and the 3D imaging mode, and image processing according to the subject and imaging condition at the time of the 2D imaging mode. Note that details of the image processing at this digital signal processing unit 24 will be described further below.

When the 2D imaging mode is selected, 2D image data processed at the digital signal processing unit 24 is outputted to a VRAM 50. On the other hand, when the 3D imaging mode is selected, 3D image data processed at the digital signal processing unit 24 is outputted to the VRAM 50. The VRAM 50 includes an A region and a B region that each store image data representing one frame image. In the VRAM 50, the image data representing one frame image is alternately rewritten between the A region and the B region. Of the A region and the B region of the VRAM 50, written image data is read from a region other than the region where image data is rewritten. The image data read from the VRAM 50 is encoded at a video encoder 28, and is outputted to the liquid-crystal monitor 30 for stereoscopic display provided on the back of the camera. With this, a 2D/3D subject image (a live view image) is displayed on a display screen of the liquid-crystal monitor 30.

While this liquid-crystal monitor 30 is stereoscopic display means capable of displaying stereoscopic images (a left viewpoint image and a right viewpoint image) by using a parallax barrier as directional images each having a predetermined directivity, this is not meant to be restrictive, and a lenticular lens may be used, or dedicated eyeglasses such as polarization glasses or liquid-crystal shutter glasses may be worn to view a left viewpoint image and a right viewpoint individually.

Also, When the shutter button of the operating unit 38 is pressed in a first stage (pressed halfway down), the image pickup device 1 starts an AF operation or an AE operation to control a focus lens in the imaging optical system 12 to a focus point via the lens driving unit 36. Also, image data outputted from the A/D converter 20 is taken into an AE detecting unit 44.

In the AE detecting unit 44, G signals on the entire screen are added up or G signals weighted differently between a screen center part and a peripheral part are added up, and the resultant value obtained by addition is outputted to the CPU 40. The CPU 40 calculates a brightness (an imaging EV value) of the subject from the integrated value inputted from the AE detecting unit 44, and determines an aperture value and an electronic shutter (a shutter speed) of the image pickup device 1 based on this imaging EV value according to a predetermined program diagram.

Here, in the program diagram, imaging (exposure) conditions formed of combinations of aperture values of the aperture and shutter speeds or combinations of these and imaging sensitivities (ISO speeds) are designed correspondingly to the brightness of the subject. By imaging under the imaging conditions determined according to the program diagram, an image with appropriate brightness can be imaged irrespectively of the brightness of the subject.

The CPU 40 controls the aperture 14 via the aperture driving unit 34 based on the aperture value determined according to the program diagram, and controls charge storage time in the image pickup device 1 via the device control unit 32 based on the determined shutter speed.

An AF processing unit 42 is a portion that performs a contrast AF process or a phase AF process. When the contrast AF process is performed, for example, high-frequency components of image data in a predetermined focus region among pieces of image data corresponding to the 1-pixel 1-microlens parts 1A are extracted, and these high-frequency components are integrated, thereby calculating an AF evaluation value indicating a focus state. AF control is performed by controlling the focus lens in the imaging optical system 12 so that this AF evaluation value is maximum. Also, to perform a phase difference AF process, a phase difference of image data in a predetermined focus region among a plurality of pieces of parallax image data corresponding to the 4-pixel 1-microlens parts 1B is detected, and a defocus amount is found based on information indicating this phase difference. AF control is performed by controlling the focus lens in the imaging optical system 12 so that this defocus amount is 0.

When the AE operation or the AF operation ends and the shutter button is pressed in the second stage (pressed down all the way down), in response to this pressing, image data outputted from the A/D converter 20 is inputted from the image input controller 22 to a memory (SDRAM) 48 for temporary storage.

The image data temporarily stored in the memory 48 is read by the digital signal processing unit 24 as appropriate.

Now, to generate a 2D image from image data corresponding to the 1-pixel 1-microlens parts 1A at the time of the 2D imaging mode, since image data corresponding to pixel positions of the 4-pixel 1-microlens parts 1B is insufficient, linear interpolation is performed on image data corresponding to the 1-pixel 1-microlens parts 1A to generate image data for covering the shortfall. Then, a predetermined signal process including a synchronization process (a process of interpolating a spatial deviation of a color signal due to the arrangement of the primary-color filters to covert the color signal to a synchronization equation) and a YC process (a process of generating luminance data and color difference data of image data) is performed on all pieces of image data including the image data corresponding to the 1-pixel 1-microlens parts 1A and the image data generated by interpolation. The YC-processed image data (YC data) is stored again in the memory 48.

Also, to generate a 2D image from the image data corresponding to the 4-pixel 1-microlens parts 1B, four pieces of image data for each 4-pixel 1-microlens part 1B are added together to generate image data for one pixel from the four pieces of image data. Furthermore, since image data corresponding to pixel positions of the 1-pixel 1-microlens parts 1A is insufficient, linear interpolation is performed on the generated image data to generate image data for covering the shortfall. Then, a predetermined signal process including a synchronization process and a YC process is performed on all pieces of image data including the image data corresponding to the 4-pixel 1-microlens parts 1B and the image data generated by interpolation. The YC data after the YC process is stored again in the memory 48.

On the other hand, to generate a 3D image from image data for four viewpoints corresponding to the 4-pixel 1-microlens part 1B at the time of the 3D imaging mode, first, since image data for four viewpoints corresponding to pixel positions of the 1-pixel 1-microlens part 1A, linear interpolation is performed on the image data for four viewpoints corresponding to the 4-pixel 1-microlens part 1B to generate image data for covering the shortfall. With this, image data for four viewpoints (four pieces) is generated.

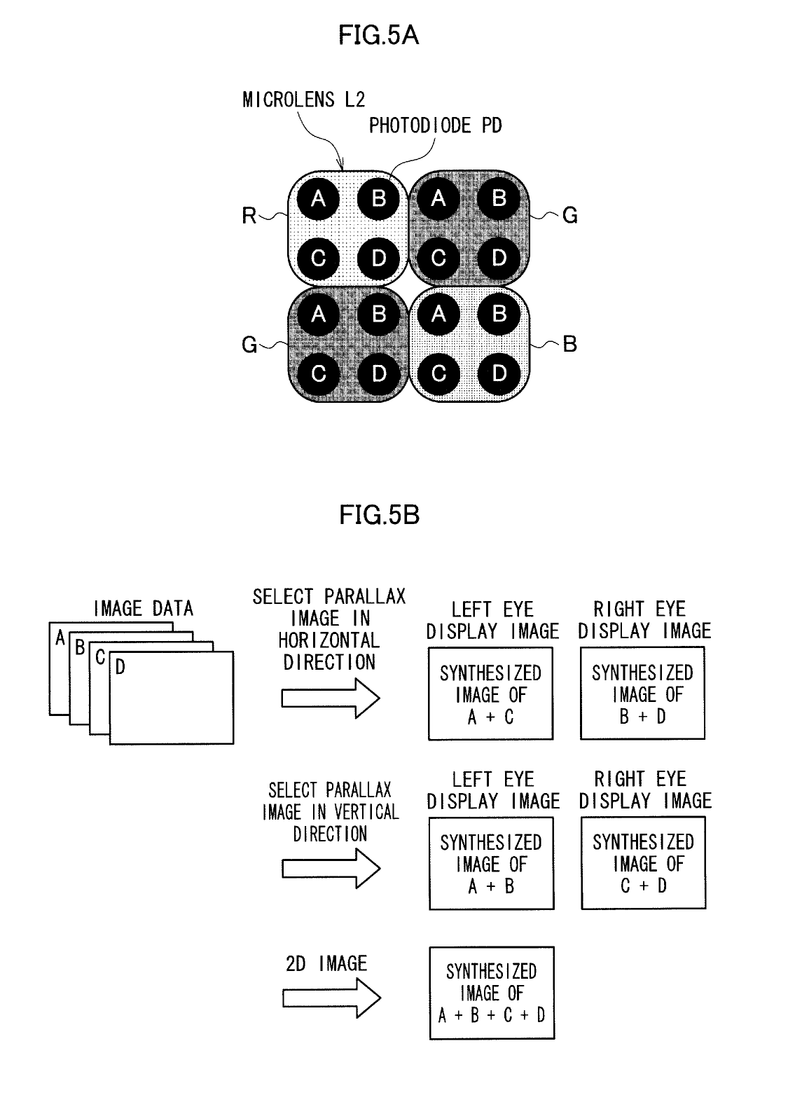

Now, the pixels of the 4-pixel 1-microlens part 1B are A, B, C, and D as depicted in FIG. 5A, four pieces of image data are generated for each of A, B, C, and D. Next, when imaging is made with the image pickup apparatus 10 placed horizontally, the pieces of image data of A and C are added together to generate a left eye display image (a left parallax image), and the pieces of image data of B and D are added together to generate a right eye display image (a right parallax image). Note that reference characters of L and R provided to four pixels of each 4-pixel 1-microlens part 1B in FIG. 1 denote a left eye display pixel and a right eye display pixel, respectively, when imaging is made with the image pickup apparatus 10 horizontally placed.

On the other hand, when imaging is made with the image pickup apparatus 10 vertically placed, the pieces of image data of A and B are added together to generate a left eye display image (a left parallax image), and the pieces of image data of C and D are added together to generate a right eye display image (a right parallax image). Note that the image pickup apparatus 10 is provided with a sensor that detects the (horizontal) posture of the image pickup apparatus 10, the pixel addition described above is selectively performed based on the posture of the image pickup apparatus 10 at the time of 3D imaging. Also, as will be described further below, with addition of the pieces of image data of A, B, C, and D together, a 2D image can also be generated.

One piece of YC data generated at the time of the 2D imaging mode and stored in the memory 48 in the above described manner is outputted to a compression/expansion processing unit 26, where a predetermined compression process is performed such as JPEG (joint photographic experts group), and then is recorded on a memory card 54 via a media controller 52. Also, two pieces (for left and right viewpoints) of YC data stored in the memory 48 are each outputted to the compression/expansion processing unit 26, where a predetermined compression process is performed such as JPEG (joint photographic experts group). A multi-picture file (an MP file: a file in a form having a plurality of images coupled together) is further generated, and that MP file is recorded on the memory card 54 via the media controller 52.

Note that while two pieces, left and right, of parallax image are generated at the time of the 3D imaging mode as depicted in FIG. 5B, this is not meant to be restrictive, and four pieces, that is, up, down, left, and right, of parallax image may be recorded as they are and image addition may be performed at the time of 3D replay as depicted in FIG. 5B for output a parallax image.

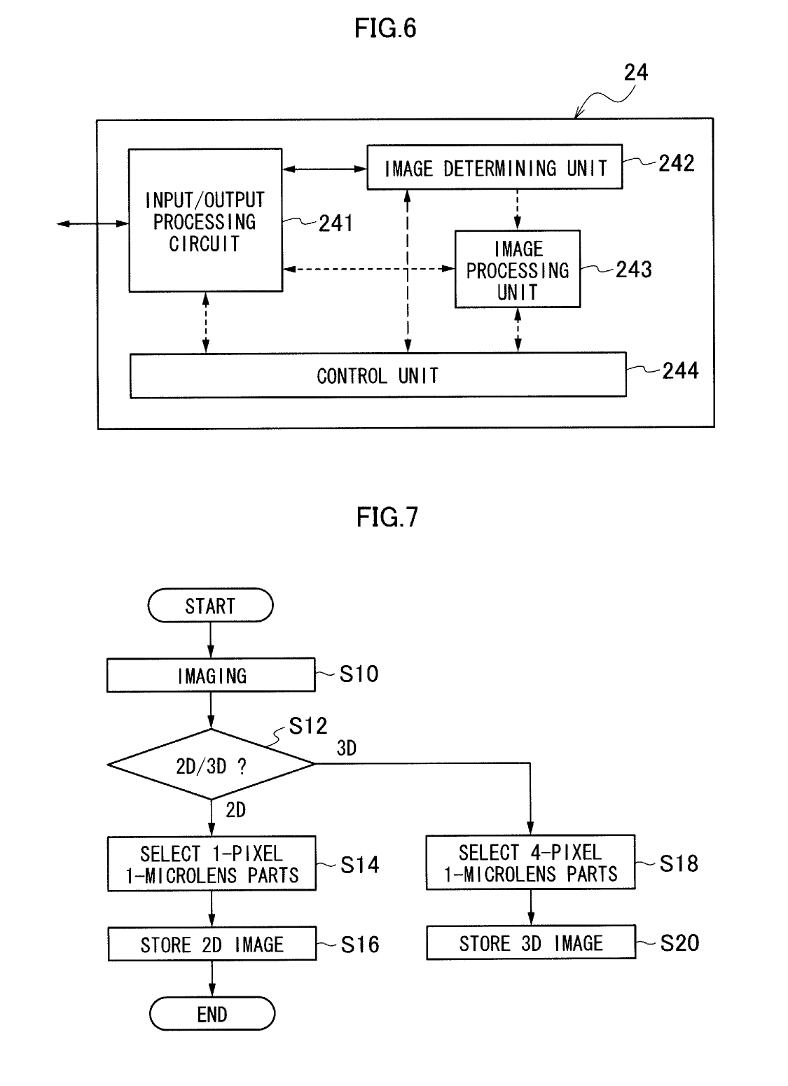

FIG. 6 is a block diagram of an internal structure of the digital signal processing unit 24. As depicted in this drawing, the digital signal processing unit 24 is configured to include an input/output processing circuit 241, an image determining unit 242, an image processing unit 243, and a control unit 244.

The input/output processing circuit 241 inputs and outputs the image data once stored in the memory 48 via the image input controller 22. The image determining unit 242 determines from the image data obtained via the input/output processing circuit 241 (the image data with the image data corresponding to the 1-pixel 1-microlens part 1A and the image data corresponding to the 4-pixel 1-microlens part 1B mixed together) whether the image data corresponding to the 1-pixel 1-microlens part 1A is to be used or the image data corresponding to the 4-pixel 1-microlens part 1B is to be used. The image processing unit 243 performs a post process of generating image data for recording from the image data obtained according to the determination result of the image determining unit 242. The control unit 244 is a portion that controls the input/output processing circuit 241, the image determining unit 242, and the image processing unit 243 in a centralized manner.

### First Embodiment

FIG. 7 is a flowchart depicting an operation of the image pickup apparatus 10 of a first embodiment of the present invention.

A photographer first operates the mode dial of the operating unit 38 to select the 2D imaging mode or the 3D imaging mode, then determines a composition while viewing a live view image (a through image) outputted to the liquid-crystal monitor 30, and perform imaging by pressing the shutter button halfway or all the way down (step S10).

Next, the CPU 40 determines whether the 2D imaging mode or the 3D imaging mode has been selected with the mode dial (step S12). If the 2D imaging mode has been selected, a transition is made to step S14. If the 3D imaging mode has been selected, a transition is made to step S18.

At step S14, the image determining unit 242 depicted in FIG. 6 determines that image data corresponding to the 1-pixel 1-microlens parts 1A is to be used from among image data having the image data corresponding to the 1-pixel 1-microlens parts 1A obtained via the input/output processing circuit 241 and the image data corresponding to the 4-pixel 1-microlens parts 1B mixed therein, and selects the image data corresponding to the 1-pixel 1-microlens parts 1A for output to the image processing unit 243.

The image processing unit 243 generates image data corresponding to pixel positions of the 4-pixel 1-microlens parts 1B by performing linear interpolation on the image data corresponding to the 1-pixel 1-microlens parts 1A to generate image data at high resolution for one screen, and also performs a predetermined signal process such as white balance correction, gamma correction, a synchronization process, and a YC process. The image data obtained by the YC process by the image processing unit 243 (YC data) is stored in the memory 48 via the input/output processing circuit 241, is subjected to a compression process by the compression/expansion processing unit 26, and is then recorded as a 2D image on the memory card 54 via the media controller 52 (step S16).

On the other hand, when a transition is made to step S18 with the imaging in the 3D imaging mode, the image determining unit 242 depicted in FIG. 6 determines that image data corresponding to the 4-pixel 1-microlens parts 1B is to be used from among image data having the image data corresponding to the 1-pixel 1-microlens parts 1A obtained via the input/output processing circuit 241 and the image data corresponding to the 4-pixel 1-microlens parts 1B mixed therein, and selects the image data corresponding to the 4-pixel 1-microlens parts 1B for output to the image processing unit 243.

The image processing unit 243 generates image data corresponding to pixel positions of the 1-pixel 1-microlens parts 1A by performing linear interpolation on the image data corresponding to the 4-pixel 1-microlens parts 1B to generate image data for four viewpoints (four pieces) as depicted in FIG. 5B and, furthermore, adds two images according to the posture of the image pickup apparatus 10 at the time of imaging to generate a left eye display image (a left parallax image) and a right eye display image (a right parallax image). Then, a predetermined signal process such as white balance correction, gamma correction, a synchronization process, and a YC process is performed. The image data obtained by the YC process by the image processing unit 243 (YC data) is stored in the memory 48 via the input/output processing circuit 241, is subjected to a compression process by the compression/expansion processing unit 26, and is then recorded as a 3D image on the memory card 54 via the media controller 52 (step S20).

### Second Embodiment

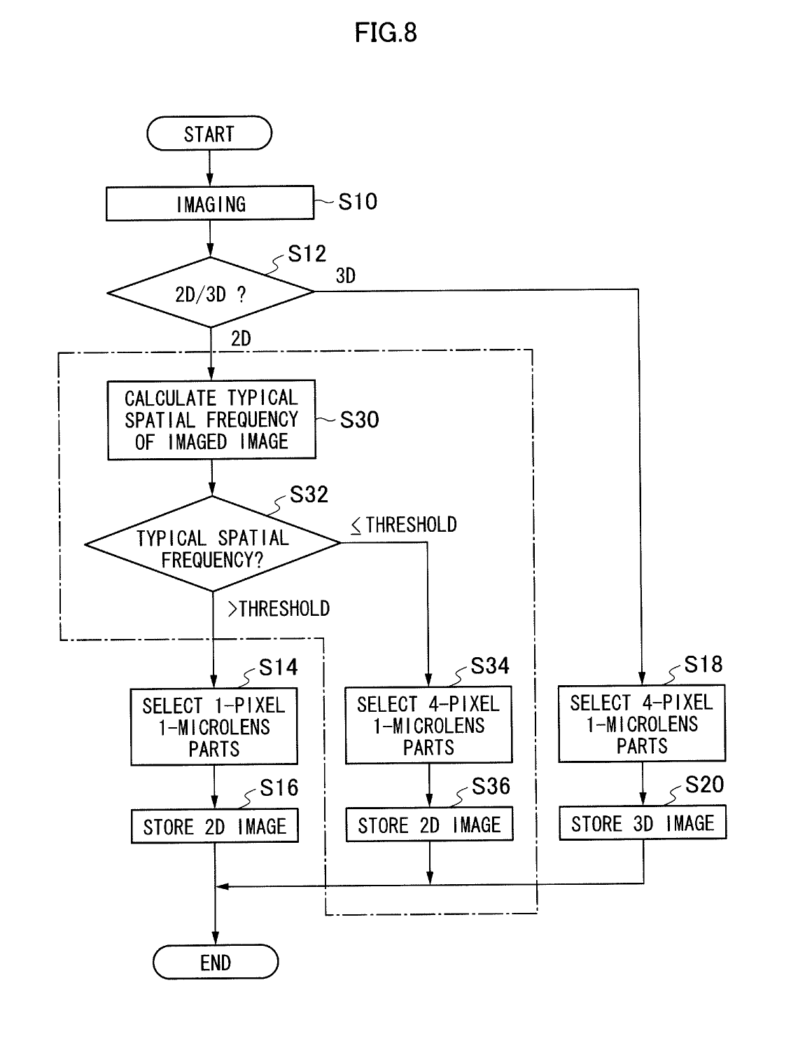

FIG. 8 is a flowchart depicting an operation of the image pickup apparatus 10 of a second embodiment of the present invention.

Note that a portion common to that of the first embodiment depicted in FIG. 7 is provided with the same step number, and its detailed description is omitted.

The second embodiment depicted in FIG. 8 is different compared with the first embodiment in that a process at steps S30, S32, S34, and S36 surrounded by a one-dot chain line is added.

At step S30, a typical spatial frequency of the image imaged at step S10 is calculated. In this embodiment, images obtained from the 1-pixel 1-microlens parts 1A are converted to a spatial frequency domain, and a spatial frequency such as an average spatial frequency of the entire screen in the spatial frequency domain (hereinafter referred to as a “typical spatial frequency”) (a first typical spatial frequency) and a typical spatial frequency (a second typical spatial frequency) of images from the 4-pixel 1-microlens parts 1B are calculated. Note that a signal of a G pixel near a luminance signal can be used as a pixel for use in calculation of the typical spatial frequencies.

Subsequently, it is determined whether the first typical spatial frequency exceeds a predetermined threshold (step S32). This determination is performed by calculating a difference between the first typical spatial frequency and the second typical spatial frequency and determining whether the difference exceeds a predetermined value (for example, a value for determining whether there is an obvious difference between both of the typical spatial frequencies). Note that determination as to whether the first typical spatial frequency exceeds the predetermined threshold is not restricted to the example above, and may be performed by comparison with a preset threshold (for example, a maximum value the second typical spatial frequency can take).

Then, when it is determined that the first typical spatial frequency exceeds the predetermined threshold, a transition is made to step S14. When it is determined that the first typical spatial frequency is the predetermined threshold or less, a transition is made to step S34. That is, when the first typical spatial frequency exceeds the predetermined threshold, the subject image includes many high-frequency components and recording as a 2D image at high resolution is preferable, and therefore a transition is made to step S14. When the first typical spatial frequency is the predetermined threshold or less, since the subject image has less high-frequency components, sensitivity is prioritized over resolution, and therefore a transition is made to step S34.

At step S34, the image determining unit 242 (FIG. 6) determines that image data corresponding to the 4-pixel 1-microlens parts 1B is to be used from among image data having the image data corresponding to the 1-pixel 1-microlens parts 1A obtained via the input/output processing circuit 241 and the image data corresponding to the 4-pixel 1-microlens parts 1B mixed therein, and selects the image data corresponding to the 4-pixel 1-microlens parts 1B for output to the image processing unit 243. Note that, at the time of the 2D imaging mode, for an image signal (an analog signal) outputted from the 4-pixel 1-microlens part 1B, the analog gain is lowered in consideration of a pixel addition of four pixels (sensitivity is lowered).

The image processing unit 243 generates a 2D image from the image data corresponding to the 4-pixel 1-microlens parts 1B. That is, four pieces of image data are added together for each 4-pixel 1-microlens part 1B to generate image data for one pixel from the four pieces of image data. Also, with linear interpolation of the generated image data, image data at pixel positions of the 1-pixel 1-microlens parts 1A is generated. Then, based on all pieces of image data including the image data corresponding to the 4-pixel 1-microlens parts 1B and the image data generated by interpolation, a predetermined signal process is performed such as white balance correction, gamma correction, a synchronization process, and a YC process. The image data obtained by the YC process by the image processing unit 243 (YC data) is stored in the memory 48 via the input/output processing circuit 241, is subjected to a compression process by the compression/expansion processing unit 26, and is then recorded as a 2D image on the memory card 54 via the media controller 52 (step S36).

### Third Embodiment

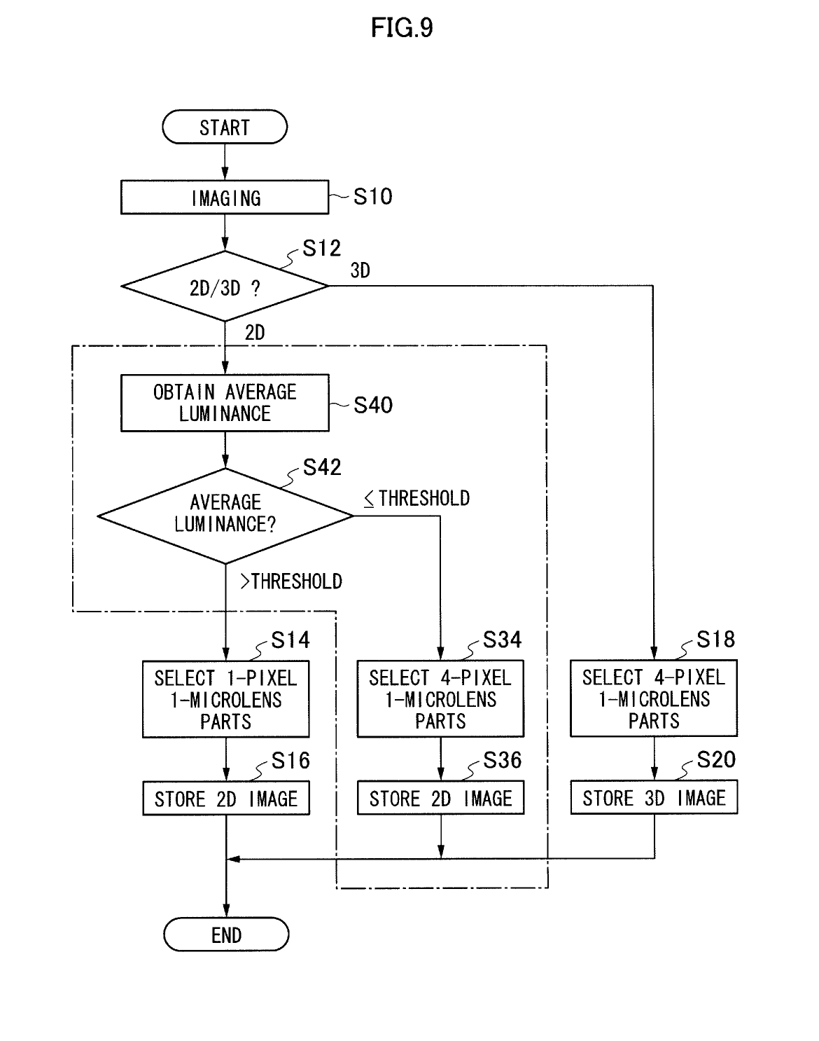

FIG. 9 is a flowchart depicting an operation of the image pickup apparatus 10 of a third embodiment of the present invention.

Note that a portion common to that of the first embodiment depicted in FIG. 7 and that of the second embodiment depicted in FIG. 8 is provided with the same step number, and its detailed description is omitted.

The third embodiment depicted in FIG. 9 is different compared with the first embodiment in that a process at steps S40, S42, S34, and S36 surrounded by a one-dot chain line is added.

At step S40, an average luminance at the time of imaging at step S10 is obtained. As this average luminance, the brightness of the subject (the imaging EV value) measured by the AE detecting unit 44 (FIG. 4) can be used.

Subsequently, it is determined whether the average luminance exceeds a predetermined threshold (step S42). As this threshold, for example, a value when the average luminance (the imaging EV value) is low and the imaging sensitivity is required to be increased is assumed.

When the average luminance exceeds the predetermined threshold (when the imaging sensitivity is not required to be increased), a transition is made to step S14.

When the average luminance is the predetermined threshold or less (when the imaging sensitivity is required to be increased), a transition is made to step S34.

At steps S34 and S36, as with the second embodiment depicted in FIG. 8, image data corresponding to the 4-pixel 1-microlens parts 1B is selected, and a 2D image is generated and recorded based on the selected image data. Note that as described above, since the analog gain is set low (the sensitivity is set low) in consideration of pixel addition of four pixels at the time of the 2D imaging mode, a 2D image with less noise compared with an image signal from the 1-pixel 1-microlens parts 1A can be obtained.

### Fourth Embodiment

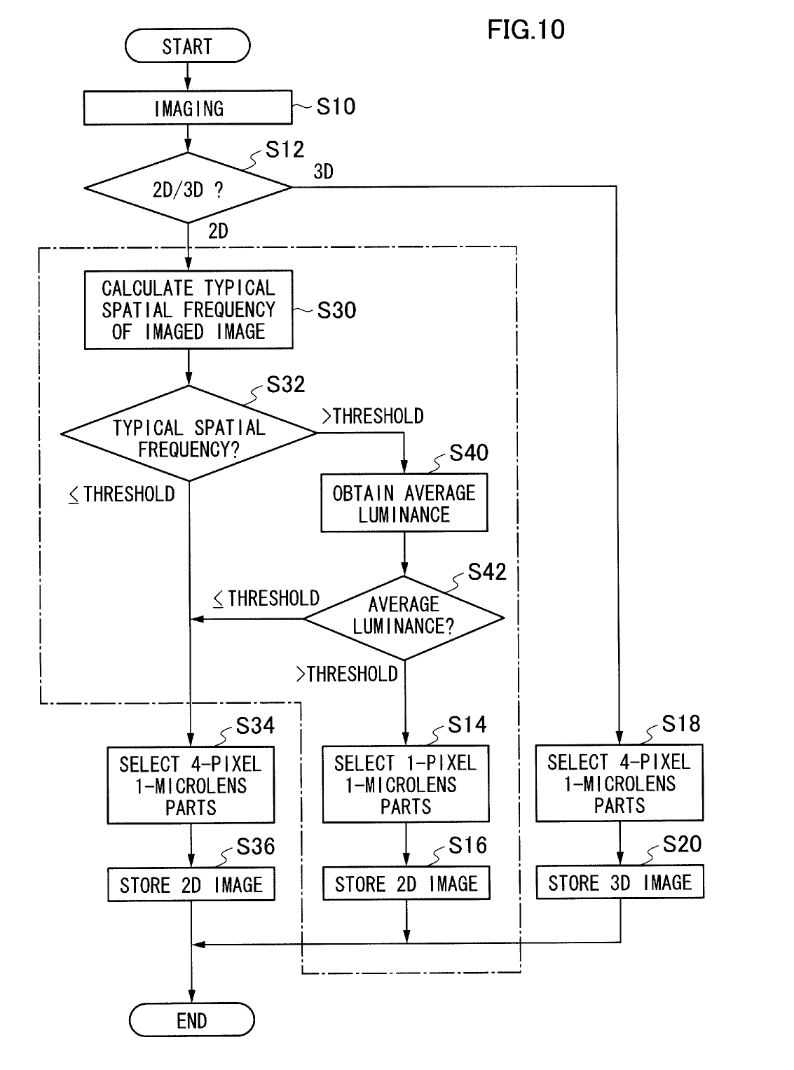

FIG. 10 is a flowchart depicting an operation of the image pickup apparatus 10 of a fourth embodiment of the present invention.

Note that a portion common to that of the first embodiment depicted in FIG. 7, that of the second embodiment depicted in FIG. 8, and that of the third embodiment depicted in FIG. 9 is provided with the same step number, and its detailed description is omitted.

The fourth embodiment depicted in FIG. 10 is different compared with the first embodiment in that a process at steps S30, S32, S34, S36, S40, and S42 surrounded by a one-dot chain line is added.

That is, only when it is determined at step S32 that the first typical spatial frequency exceeds the predetermined threshold and it is determined at step S42 that the average luminance exceeds the predetermined threshold, a 2D image is generated and recorded based on the image data outputted from the 1-pixel 1-microlens parts 1A. Otherwise, a 2D image is generated and recorded based on the image data outputted from the 4-pixel 1-microlens parts 1B.

In the case of an imaging environment where a sufficient brightness cannot be obtained, an image with less noise is often required even if the image is at resolution lower than that of an image at high resolution. According to the fourth embodiment, if the average luminance is the predetermined luminance or less, a two-dimensional image is generated based on a second output signal outputted from the 4-pixel 1-microlens part 1B even if the first typical spatial frequency exceeds the predetermined threshold (the image includes many high-frequency components).

### Fifth Embodiment

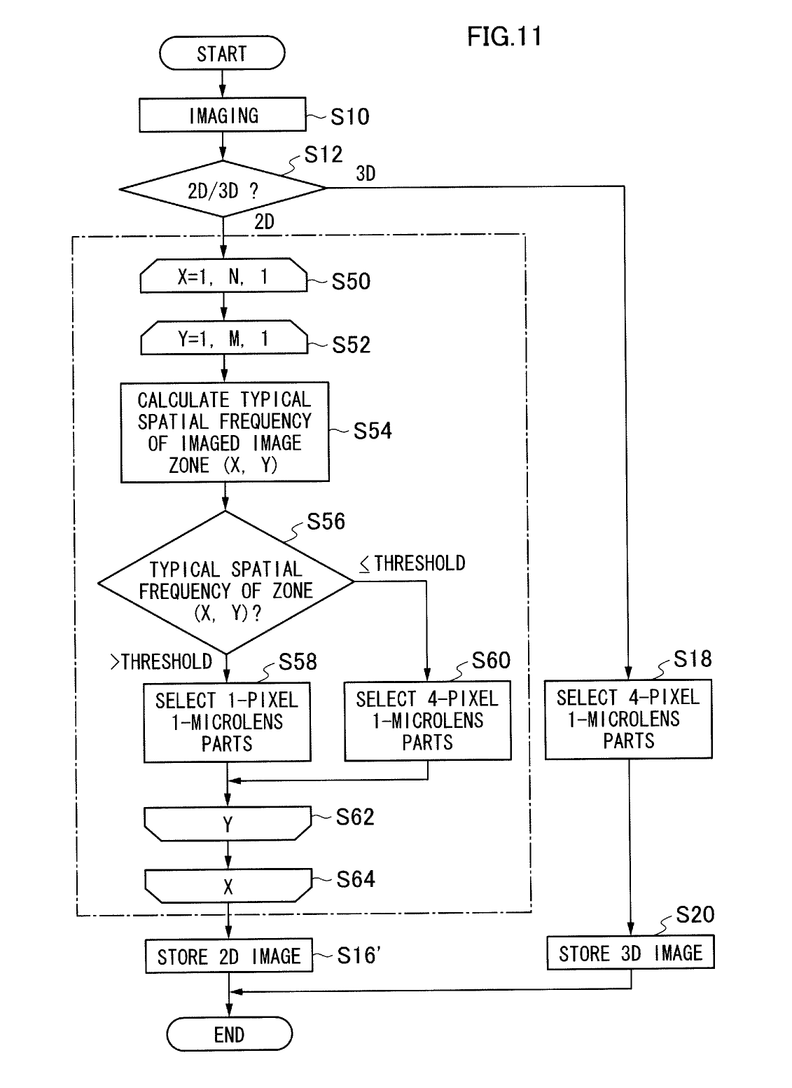

FIG. 11 is a flowchart depicting an operation of the image pickup apparatus 10 of a fifth embodiment of the present invention.

Note that a portion common to that of the first embodiment depicted in FIG. 7 is provided with the same step number, and its detailed description is omitted.

The fifth embodiment depicted in FIG. 11 is different compared with the first embodiment in that a process at steps S50 to S64 surrounded by a one-dot chain line is added.

In the fifth embodiment, one imaged screen is divided to N×M, and a typical spatial frequency is calculated for each divisional area obtained by N×M division. The size of the divisional area is preferably as small as possible within a range in which a typical spatial frequency can be calculated. It is then determined whether the image data of the 1-pixel 1-microlens parts 1A or the image data of the 4-pixel 1-microlens part 1B is selected for each divisional area.

Step S50 is a pre-determining unit that repeatedly causes a process with step S64 by setting an initial value of a variable X at 1, a final value at N, and an increment at 1 while changing the variable X, and step S52 is a pre-determining unit that repeatedly causes a process with step S62 by setting an initial value of a variable Y at 1, a final value at M, and an increment at 1 while changing the variable Y. With these, a double-looped repeating process is performed.

At step S54, a typical spatial frequency of a divisional area ZONE(X, Y) of the imaged image is calculated. At step S56, it is determined whether the calculated typical spatial frequency of the divisional area ZONE(X, Y) exceeds a threshold. This determination is performed in a manner similar to that of the second embodiment (step S32 in FIG. 8).

Then, when it is determined that the typical spatial frequency of the divisional area ZONE(X, Y) exceeds the threshold, the image data of the 1-pixel 1-microlens parts 1A in that divisional area ZONE(X, Y) is selected and temporarily stored (step S58). On the other hand, when it is determined that the typical spatial frequency of the divisional area ZONE(X, Y) is the threshold or less, the image data of the 4-pixel 1-microlens parts 1A in that divisional area ZONE(X, Y) is selected and temporarily stored. By performing the repeating process in the double loop, the image data of the 1-pixel 1-microlens parts 1A or the image data of the 4-pixel 1-microlens parts 1B is selected for all of N×M divisional areas ZONE(X, Y).

At step S16′, a 2D image is generated based on image data for one screen having the image data of the 1-pixel 1-microlens parts 1A and the image data of the 4-pixel 1-microlens parts 1B thus selected mixed therein. In this case, the number of pixels of the 2D image of a divisional area generated based on the image data of the 4-pixel 1-microlens parts 1B is different from the number of pixels of the 2D image of a divisional area generated based on the image data of the 1-pixel 1-microlens parts 1A. Therefore, one pixel of the 2D image of the divisional area generated based on the 4-pixel 1-microlens parts 1B is made to four pixels by interpolation or the like, thereby making the number of pixels of each divisional area the same. That is, while step S16′ is different from step S16 of FIG. 7 of the first embodiment in that the processing of making the number of pixels of each divisional area the same, other processes to be performed are similar to those at step S16, thereby generating and storing a 2D image.

According to the fifth embodiment, it is possible to generate a 2D image using optimum image data according to the target to be imaged (whether the subject include high-frequency components).

### [Others]

The method of selecting the image data of the 1-pixel 1-microlens parts 1A or the image data of the 4-pixel 1-microlens parts 1B for use at the time of the 2D imaging mode is not meant to be restricted to these embodiments. For example, when the size of the image to be recorded is set at one quarter of a maximum image size, the image data of the 4-pixel 1-microlens parts 1B may be used.

Also, while the image data of the 1-pixel 1-microlens parts 1A or the image data of the 4-pixel 1-microlens parts 1B is selected depending on whether the typical spatial frequency of the image exceeds the threshold in the embodiments, this is not meant to be restrictive. For example, high-frequency components included in the image may be extracted by a high-pass filter, and the image data of the 1-pixel 1-microlens parts 1A or the image data of the 4-pixel 1-microlens parts 1B may be selected for use based on the size of the integrated value of the extracted high-frequency components. In short, it is sufficient to determine whether the image includes many high-frequency components and, based on the determination result, select the image data of the 1-pixel 1-microlens parts 1A or the image data of the 4-pixel 1-microlens parts 1B for use.

Furthermore, the present invention is not meant to be restricted to the embodiments described above, and it is needless to say that various modifications are possible within a range not deviating from the spirit of the present invention. For example, the number of pixels to be allocated to one microlens part 1B may be 2×2=4 pixels as well as 3×3=9 pixels, 4×4=16 pixels, or n×n (n: an integer of 2 or more) pixels. Accordingly, the pixel unit of the 1-pixel 1-microlens part 1A may be 2×2=4 pixels, 3×3=9 pixels, 4×4=16 pixels, or n×n (n: an integer of 2 or more) pixels.

### REFERENCE SIGNS LIST

1, 1′ . . . image pick up device, 1A . . . 1-pixel 1-microlens part, 1B . . . 4-pixel 1-microlens part, 10 . . . image pickup apparatus, 12 . . . imaging optical system, 14 . . . aperture, 24 . . . digital signal processing unit, 30 . . . liquid crystal monitor, 38 . . . operating unit, 40 . . . central processing unit (CPU), 42 . . . AF processing unit, 44 . . . AE detecting unit, 46 . . . ROM, 48 . . . memory, 54 . . . memory card, 241 . . . input/output processing circuit, 242 . . . image determining unit, 243 . . . image processing unit, 244 . . . control unit, L1, L2 . . . microlens, PD . . . photodiode

1. An image pickup device, comprising:
a plurality of photoelectric conversion elements arranged in a row direction and a column direction on a semiconductor substrate;
a first microlens, which is one microlens provided above one of the photoelectric conversion elements, the first microlens guiding light entering the microlens to a light receiving surface of the one photoelectric conversion element; and
a second microlens, which is one microlens provided above n×n (n: an integer of 2 or more) of the photoelectric conversion elements laterally and longitudinally adjacent to each other, the second microlens pupil-dividing light entering the microlens for guiding to a light receiving surface of each of the n×n photoelectric conversion elements,
the first microlens and the second microlens being provided in a mixed manner so that a two-dimensional image and a three-dimensional image can be respectively generated based on at least a first output signal from the photoelectric conversion element corresponding to the first microlens and a second output signal from any of the photoelectric conversion elements corresponding to the second microlens,
of color filters of a plurality of colors, color filters of any of the colors being provided above the plurality of photoelectric conversion elements, and
color filters of a same color being provided to the n×n photoelectric conversion elements corresponding to the second microlens.

2. The image pickup device according to claim 1, wherein
the number of photoelectric conversion elements where the first microlens is provided and the number of photoelectric conversion elements where the second microlens is provided are equal to each other.

3. The image pickup device according to claim 1, wherein
4×4 photoelectric conversion elements are taken as one block, and a first region where sixteen first microlenses are provided to one block and a second region where four second microlenses are provided to one block are arranged in a checkered manner.

4. The image pickup device according to claim 2, wherein
4×4 photoelectric conversion elements are taken as one block, and a first region where sixteen first microlenses are provided to one block and a second region where four second microlenses are provided to one block are arranged in a checkered manner.

5. The image pickup device according to claim 1, wherein
2×2 photoelectric conversion elements are taken as one block, and a first region where four first microlenses are provided to one block and a second region where one second microlenses are provided to one block are arranged in a checkered manner.

6. The image pickup device according to claim 2, wherein
2×2 photoelectric conversion elements are taken as one block, and a first region where four first microlenses are provided to one block and a second region where one second microlenses are provided to one block are arranged in a checkered manner.

7. An image pickup apparatus, comprising:
a single imaging optical system;
the image pickup device according to claim 1 where the subject image is formed via the imaging optical system;
an imaging mode selecting unit that switches between a 2D imaging mode for imaging a two-dimensional image and a 3D imaging mode for imaging a three-dimensional image;
a first image generating unit that generates a two-dimensional image based on a first output signal outputted from the photoelectric conversion element corresponding to the first microlens of the image pickup device when the 2D imaging mode is selected by the imaging mode selecting unit;
a second image generating unit that generates a three-dimensional image based on a second output signal outputted from the photoelectric conversion element corresponding to the second microlens of the image pickup device when the 3D imaging mode is selected by the imaging mode selecting unit; and
a recording unit that records the two-dimensional image generated by the first image generating unit or the three-dimensional image generated by the second image generating unit.

8. An image pickup apparatus, comprising:
a single imaging optical system;
the image pickup device according to claim 1 where the subject image is formed via the imaging optical system;
an imaging mode selecting unit that switches between a 2D imaging mode for imaging a two-dimensional image and a 3D imaging mode for imaging a three-dimensional image;
a determining unit that determines whether an image imaged via the imaging optical system and the image pickup device includes many high-frequency components;
a first image generating unit that generates a two-dimensional image based on a first output signal outputted from the photoelectric conversion element corresponding to the first microlens of the image pickup device when the 2D imaging mode is selected by the imaging mode selecting unit and it is determined by the determining unit that the image includes many high-frequency components, and generates a two-dimensional image based on a second output signal outputted from the photoelectric conversion element corresponding to the second microlens of the image pickup device when it is determined by the determining unit that the image does not include many high-frequency components; and
a second image generating unit that generates a three-dimensional image based on the second output signal outputted from the photoelectric conversion element corresponding to the second microlens of the image pickup device when the 3D imaging mode is selected by the imaging mode selecting unit; and
a recording unit that records the two-dimensional image generated by the first image generating unit or the three-dimensional image generated by the second image generating unit.

9. The image pickup apparatus according to claim 8, further comprising a brightness detecting unit that detects a brightness of a subject, wherein
the first image generating unit generates a two-dimensional image based on the first output signal outputted from the photoelectric conversion element corresponding to the first microlens of the image pickup device when the 2D imaging mode is selected by the imaging mode selecting unit, it is determined by the determining unit that the image includes many high-frequency components, and the detected brightness of the subject exceeds a predetermined threshold, and generates a two-dimensional image based on the second output signal outputted from the photoelectric conversion element corresponding to the second microlens of the image pickup device when it is determined by the determining unit that the image does not include many high-frequency components or when the detected brightness of the subject is the predetermined threshold or less.

10. An image pickup apparatus, comprising:
a single imaging optical system;
the image pickup device according to claim 1 where the subject image is formed via the imaging optical system;
an imaging mode selecting unit that switches between a 2D imaging mode for imaging a two-dimensional image and a 3D imaging mode for imaging a three-dimensional image;
a brightness detecting unit that detects a brightness of a subject;
a first image generating unit generates a two-dimensional image based on the first output signal outputted from the photoelectric conversion element corresponding to the first microlens of the image pickup device when the 2D imaging mode is selected by the imaging mode selecting unit, and the detected brightness of the subject exceeds a predetermined threshold, and generates a two-dimensional image based on the second output signal outputted from the photoelectric conversion element corresponding to the second microlens of the image pickup device when the detected brightness of the subject is the predetermined threshold or less;
a second image generating unit that generates a three-dimensional image based on the second output signal outputted from the photoelectric conversion element corresponding to the second microlens of the image pickup device when the 3D imaging mode is selected by the imaging mode selecting unit; and
a recording unit that records the two-dimensional image generated by the first image generating unit or the three-dimensional image generated by the second image generating unit.

11. An image pickup apparatus, comprising:
a single imaging optical system;
the image pickup device according to claim 1 where the subject image is formed via the imaging optical system;
an imaging mode selecting unit that switches between a 2D imaging mode for imaging a two-dimensional image and a 3D imaging mode for imaging a three-dimensional image;
a determining unit that determines whether an image imaged via the imaging optical system and the image pickup device includes many high-frequency components, determining whether the image includes many high-frequency components for each divisional area obtained by N×M division of one screen;
a first image generating unit that, when the 2D imaging mode is selected by the imaging mode selecting unit and it is determined that the image is in a divisional area including many high-frequency components, obtains, for the divisional area, a first output signal outputted from the photoelectric conversion element corresponding to the first microlens of the image pickup device, obtains a second output signal outputted from the photoelectric conversion element corresponding to the second microlens of the image pickup device when it is determined that the image is in a divisional area not including many high-frequency components, and generates a two-dimensional image based on the obtained first output signal and second output signal;
a second image generating unit that generates a three-dimensional image based on the second output signal outputted from the photoelectric conversion element corresponding to the second microlens of the image pickup device when the 3D imaging mode is selected by the imaging mode selecting unit; and
a recording unit that records the two-dimensional image generated by the first image generating unit or the three-dimensional image generated by the second image generating unit.

12. The image pickup apparatus according to claim 7, wherein
the second image generating unit generates parallax images of four viewpoints from above, below, left and right or parallax images of two viewpoints from above and below or from left and right, based on a second output signal outputted from the photoelectric conversion element corresponding to the second microlens of the image pickup device.

13. The image pickup apparatus according to claim 8, wherein
the second image generating unit generates parallax images of four viewpoints from above, below, left and right or parallax images of two viewpoints from above and below or from left and right, based on a second output signal outputted from the photoelectric conversion element corresponding to the second microlens of the image pickup device.

14. The image pickup apparatus according to claim 9, wherein
the second image generating unit generates parallax images of four viewpoints from above, below, left and right or parallax images of two viewpoints from above and below or from left and right, based on a second output signal outputted from the photoelectric conversion element corresponding to the second microlens of the image pickup device.

15. The image pickup apparatus according to claim 10, wherein
the second image generating unit generates parallax images of four viewpoints from above, below, left and right or parallax images of two viewpoints from above and below or from left and right, based on a second output signal outputted from the photoelectric conversion element corresponding to the second microlens of the image pickup device.

16. The image pickup apparatus according to claim 11, wherein
the second image generating unit generates parallax images of four viewpoints from above, below, left and right or parallax images of two viewpoints from above and below or from left and right, based on a second output signal outputted from the photoelectric conversion element corresponding to the second microlens of the image pickup device.
